(19) United States
(12) Patent Application Publication
(10) Pub. No.: US 2009/0301005 A1
(43) Pub. Date: Dec. 10, 2009

(54) COMPOSITE STRUCTURE FOR WINDOW SASH, DOOR FRAME, AND THE LIKE

(75) Inventor: Bruce Harvey Woodfield, Palmerston North (NZ)

Correspondence Address: Workman Nydegger;1000 Eagle Gate Tower, 60 East South Temple, Salt Lake City, UT, 84111, US

(73) Assignee: Blueskye Innovations Limited, Palmerston North (NZ)

(21) Appl. No.: 12/093,577

(22) PCT Filed: Nov. 15, 2006
(86) PCT No.: PCT/NZ06/00298

§ 371 Date: Sep. 23, 2008

(30) Foreign Application Priority Data
Nov. 16, 2005 (NZ) 543620

(51) Int. Cl. E06B 1/32

(52) U.S. Cl. 52/204.1

(57) ABSTRACT

A sash (4) has an elongate framing member (5, 6) and an elongate retainer (30) for holding a glazing assembly (20) in a rebate (8) in the framing member. The framing member and retainer each have generally constant transverse cross-sections. The retainer has opposite longitudinal sides (31, 32) and a longitudinal intermediate portion (33) which includes a projection (50). The first side cantilevers over the rebate in the framing member. The projection has an L-shaped cross-section with a distal limb that extends toward the cantilevered first side for interlocking the retainer with the framing member, such as by engagement with clip (40) mounted on the framing member. The retainer can be secured to the framing member by a fastener (37A) which is inaccessible when the sash is closed in a frame. In a preferred embodiment the retainer and clip are aluminium extrusions and the framing member is made of timber.

### FIELD OF INVENTION

The present invention relates to a frame construction for a window sash, door frame, or the like. The invention has particular application to a composite framing structure for rails and stiles of a window or door sash, the framing structure having a timber structural frame exposed at an interior side and an extruded aluminium profile covering the timber frame at an exterior side.

### BACKGROUND

Traditional timber window joinery requires significant maintenance to combat the effects of exposure to weather. The use of aluminium, while going some way toward improving weather resistance and reducing maintenance, has introduced other problems. Aluminium, being a good thermal conductor, has increased thermal energy losses and has also created problems with excessive condensation of airborne moisture on internal surfaces.

Aluminium is readily extruded in constant cross-section profiles making it particularly suitable for the often complex shapes required in window and door framing; for example capillary breaks, drain channels, rebates for retaining glazing, kerfs for retaining rubber seals, and sockets for threaded screw fasteners used at corner joints can all be readily and accurately formed by extrusion. Aluminium can also be readily finished in a wide range of colours, such as by anodising or powdercoating. However, aluminium is not always perceived as aesthetically pleasing in some situations, for example in domestic homes, where the more traditional ambience and warmth of a true timber finish is valued, and especially so indoors.

One approach has been an attempt to combine the best of both materials by providing a sash frame with interior surfaces being at least predominantly timber and exterior surfaces being largely aluminium.

The ALTI range of composite aluminium and timber windows described at www.altinz.co.nz and the Timberview range of timber-aluminium windows described at www.alvista.co.nz/timberview.htm, both appear to have an exterior aluminium structural frame with an interior timber facing.

U.S. Pat. No. 5,768,836 (Bachmann) describes a window structure having an interior wooden sash frame with an external rebate accommodating glazing. The glazing is secured in the sash by an aluminium rail. The rail is hooked into a groove formed in a cross element and has a cantilevered arm terminating at an elastic glass holder. The cross element is screwed to the wooden frame. Similarly, an exterior fixed frame rail is made of aluminium and is supported by an interior stationary wooden frame.

The Clad Casemaster window of Marvin Lumber and Cedar Company, USA, (Marvin), has a fixed frame and a sash, each made with a pine wood interior and an aluminium exterior. External aluminium extrusions are attached to internal wooden structural frames. The aluminium extrusions have cantilevered arms that retain glazing assemblies in external rebates in the wooden sash frame. The head, sill and jambs of the fixed frame are also covered by respective aluminium extrusions.

Composite aluminium-timber windows of Swedish Window Company Limited, Suffolk, England, (Swedish), have frames and sashes with external structural sections of aluminium attached to internal timber sections. A cantilevered arm of the aluminium section retains a glazing assembly in an external rebate in the timber section.

The sashes of Hvidbjerg Vinduet Alux windows, for example the Alux sidehung Type A24.000, (Alux), have an external aluminium profile mounted by plastic clips to an internal timber section. Glazing assemblies are retained in an external rebate in the timber section by a cantilevered arm on the aluminium profile. Fixed frame edges and drain zones are also made in aluminium.

The “H window” shown at www.hwindow.com has an interior wooden sash frame with a shallow external rebate accommodating a glazing assembly. The depth of the glazing rebate is augmented by an aluminium profile attached to the exterior of the wooden frame. The glazing assembly is retained in place by a second aluminium profile that is snapped into place over a pair of projections formed on the first profile.

United Kingdom patent application GB 1,380,369 describes a putty-less glazing system for a composite window sash. U-shaped holders are screwed to a wooden frame. A metallic frame has a longitudinal flange which engages snap elements on the holders to secure a glazing unit in a rabbet in the wooden frame.

United Kingdom patent application GB 2,115,050 describes a glazing strip for a wooden framed window. The glazing strip secures a pane in a rebate and protects the frame against the effects of the weather. The strip has a flange which is snap-fitted into an anchorage channel to resist movement at right angles to the pane.

In the two United Kingdom patent applications and in each of the Bachmann, Marvin, Swedish, Alux, and H window systems, a window has a rebate in the external side of an internal structural timber profile. A glass pane, or an assembly of panes, is held in the rebate by an external aluminium or metal profile or extrusion which is clipped onto a second extrusion or holder that is attached to the timber profile. The glass is retained in place by a cantilevered portion of the external aluminium profile. A resilient seal is located between the outer face of the glass and an outer edge of the cantilever.

In United Kingdom patent application GB 1,380,369 and in each of Bachmann, Marvin, Swedish, and Alux, the direction of movement by which the external profile is engaged with the internal timber profile is substantially perpendicular to the plane of the glass being retained. The perpendicular movement compresses a resilient seal located under the edge of the cantilevered portion of the external aluminium profile. When replacing the glass in Bachmann, Swedish, and Alux, the resilient seal is first removed to release the external aluminium profile. However, this can also be done as a prelude to dismantling the window to gain unauthorised access.

In the H window, the movement required to snap the second profile into position to retain and seal the glazing assembly in the frame, first increases the pressure applied to the glass by the peripheral seal, but then decreases that pressure once the profile is snapped in its final position. This sequence of increase and decrease in applied pressure compromises the ease of assembly with the effectiveness of the finished seal. Furthermore, the outermost second profile can be relatively easily removed by a burglar or other person seeking unauthorised access, simply by prising one end of the profile outward and moving the profile toward the centre of the window.

### SUMMARY OF INVENTION

One object of at least some embodiments of the invention is to provide a composite frame construction for a window sash or door that overcomes some of the abovementioned disadvantages of the prior art, or at least provides the public with a useful choice.

A second object of at least some embodiments of the invention is to provide a composite frame construction for a window sash or door, the construction having an external profile that is attached to an internal member in a manner that discourages unauthorised dismantling of the structure in use when installed in a building. The present invention may be broadly said to be a frame construction for supporting a panel member in a door or window sash;

the frame construction comprising a framing member which is elongate and has a rebate for accommodating a peripheral portion of the panel member, the framing member having a transverse cross-sectional shape which is substantially constant along at least a major portion of the length of the framing member; and

the frame construction also comprising a retaining member for retaining the panel member in the rebate, wherein the retaining member is elongate and has a transverse cross-sectional shape which is substantially constant along at least a major portion of the length of the retaining member, the retaining member has first and second longitudinal side portions which are respectively located on opposite sides of a longitudinal intermediate portion, the first side portion of the retaining member cantilevers over the rebate in the framing member, the intermediate portion of the retaining member includes a projection which has an L-shaped cross-section with a distal limb of the L-shaped cross-section extending away from a proximal limb of the L-shaped cross-section in a direction toward the cantilevered first side portion, and the retaining member is interlocked with the framing member by engagement of the distal limb of the L-shaped cross-section of the projection of the intermediate portion of the retaining member with the framing member.

Preferably a seal is fitted to a distal edge of the cantilevered first side portion of the retaining member. More preferably, the seal is a rubber seal, and the seal is secured to the retaining member by fitting at least partially into a groove formed in the retaining member at the distal edge.

Preferably, the frame construction further comprises a panel member, a peripheral portion of the panel member being accommodated in the rebate. More preferably, a distal edge of the cantilevered first side portion of the retaining member applies a steady or monotonically increasing pressure to the peripheral portion of the panel member accommodated in the rebate when the intermediate portion of the retaining member is being interlocked with the framing member and the second side portion of the retaining member is being fastened to the framing member. The panel member may be a sheet of glass, or a glazing assembly. The glazing assembly may comprise two or more sheets of glass spaced apart from one another by at least one spacer.

Preferably the framing member comprises a substrate and at least one clip, the at least one clip is fastened to the substrate, and the retaining member is interlocked with the framing member by engagement of the distal limb of the L-shaped cross-section of the projection of the intermediate portion of the retaining member with the clip. The substrate may be made of timber. Preferably the at least one clip is elongate and has a transverse cross-sectional shape which is substantially constant along at least a major portion of the length of the clip. Preferably the at least one clip is an aluminium extrusion. The at least one clip may be fastened to the substrate by at least one fastener.

Preferably the retaining member is an aluminium extrusion.

Preferably the second side portion of the retaining member is fastened to the framing member by at least one fastener. Preferably the frame construction is incorporated into a sash mounted in a frame and the second side portion of the retaining member is fastened to the framing member by at least one fastener which is inaccessible when the sash is closed in the frame.

Preferably the second side portion of the retaining member extends from the intermediate portion firstly in a direction away from the cantilevered first side portion, then secondly, at a first return portion, in an opposite direction back toward the cantilevered first side portion. More preferably the first return portion is fastened to the framing member by at least one fastener. Preferably the frame construction is incorporated into a sash mounted in a frame and the first return portion is fastened to the framing member by at least one fastener which is inaccessible when the sash is closed in the frame.

The first return portion of the second side portion of the retaining member may have a further return portion which extends in a direction away from the intermediate portion of the retaining member. The further return portion may be fastened to the framing member by at least one fastener. Preferably the frame construction is incorporated into a sash mounted in a frame and the further return portion is fastened to the framing member by at least one fastener which is inaccessible when the sash is closed in the frame. Preferably any one of the fasteners is a threaded screw fastener.

The invention may further be said to consist in any alternative combination of parts or features mentioned herein or shown in the accompanying drawings. Known equivalents of these parts or features which are not expressly set out are nevertheless deemed to be included.

### BRIEF DESCRIPTION OF DRAWINGS

Preferred embodiments of the invention will now be further described, by way of example only and without intending to be limiting, with reference to the accompanying drawings of which:

FIG. 1 shows a cross-section of the bottom rail of an upper window sash and the top rail of a lower window sash at a transom of a window frame;

FIG. 2 shows a cross-section of the top rail of a window sash at the head of a window frame installed in the external wall of a timber framed building;

FIG. 3 shows a cross-section of the bottom rail of a window sash at the sill of a window frame installed in the external wall of a timber framed building; and

FIG. 4 shows a cross-section of a partly-assembled bottom rail of a window sash.

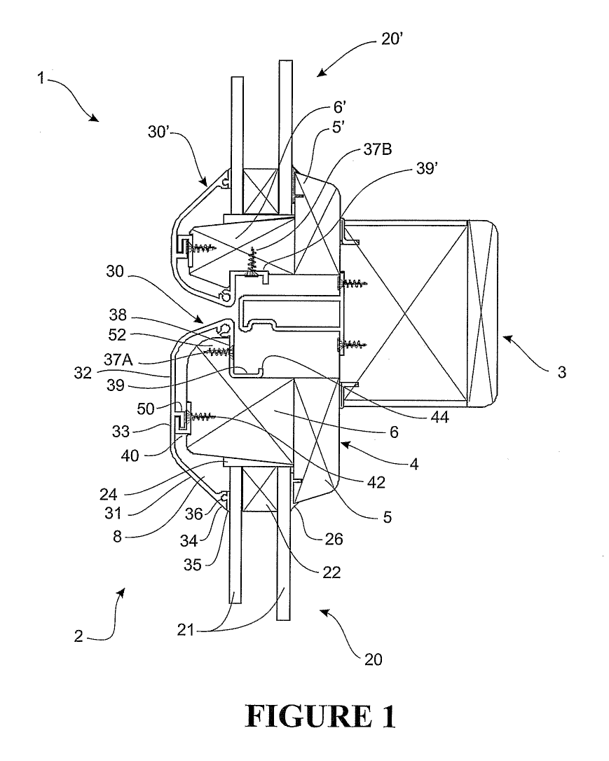

FIGS. 1 to 3 show the sashes in position when closed in the respective window frames, with the exterior side of the window frame at the left side of the figure and the interior side of the window frame is at the right side of the figure.

### DETAILED DESCRIPTION OF THE PREFERRED EMBODIMENTS

It will be appreciated that window sashes and doors can be implemented in various forms while incorporating the current invention. The following description refers to the embodiments shown in the drawings which are given, by way of example only, as a typical application of the invention in a window sash. However, it is to be understood that the invention is not limited to the embodiments shown and may also be applied to other frames, such as door frames for example.

FIG. 1 is a cross-sectional view of the bottom rail 1 of an upper sash adjacent the top rail 2 of a lower sash at a transom 3 of a window frame. For the purposes of explanation, the invention will initially be described with reference to the structure of the top rail 2 of the lower sash, as shown in FIG. 1.

The top rail 2 of the lower sash has a structural framing member 4, generally at the interior side of the window. The structural framing member 4 is made from timber and provides strength and rigidity to the sash. The structural framing member 4 may be made by laminating a facing 5 over a substrate 6. For example, an aesthetic timber facing, exposed at the interior side of the window, may be laminated over a finger jointed pine substrate 6. Some examples of aesthetic timbers for use as the interior facing include beech, ash, pine, oak, cherry, mahogany or cypress. These facings can be clear finished to enhance and preserve the natural beauty of the timber.

A rebate 8 formed in the structural framing member 4 accommodates a peripheral portion of a double glazing assembly 20. The glazing assembly is in the form of two sheets of glass 21 which are spaced apart by a spacer 22 at the periphery of the glass sheets. The spacer is typically a seal which extends completely around the periphery of the glazing assembly to hermetically seal the space between the two sheets of glass. The glazing assembly is supported in the rebate by a bevelled packer 24. A resilient interior seal 26, preferably made of a rubber or rubber-like material, is located between the glass surface at the interior face of the glazing assembly and the structural framing member 4 to seal against intrusion of condensation or other moisture or contaminants between the glass and the timber framing.

In other embodiments, not shown, a single sheet of glass, or a triple glazing assembly, or a substantially planar panel of another material (for example, plywood, sheet metal, or mesh), may be supported by the framing member with a peripheral portion of the substantially planar panel accommodated in the rebate of the framing member.

As will be understood by persons skilled in the art of joinery, sashes and door frames are commonly rectangular and utilise four framing members along respective edges of the sash or frame, with the framing members being mitred together at the four comers.

Each framing member 4 is elongate and has a transverse cross-section which is substantially constant along its length. Some examples of localised variation of the cross-section include apertures for fasteners, as will be described further below, and shaping to accommodate corner gussets at the mitred comers of the sash. The cross-sectional profile, including the rebate, may be provided by machining as is well known in the manufacture of joinery components.

The exterior side of the framing member 4 is covered by an elongate retainer 30 which has a transverse cross-section which is substantially constant along its length. The retainer is preferably an aluminium extrusion. The retainer has a first longitudinal side portion 31 and a second longitudinal side portion 32 located respectively on opposite sides of a longitudinal intermediate portion 33. The retainer is attached to the framing member by interlocking the intermediate portion 33 of the retainer to a clip 40 that is fastened to the timber framing substrate 6 by threaded screw fasteners 42.

The clip 40 is an elongate aluminium extrusion and has a generally U-shaped transverse cross-section which is substantially constant along the length of the clip.

The first elongate side portion 31 of the retainer 30 cantilevers over the rebate 8. A distal edge 34 of the first side portion rests against, or directly or indirectly applies pressure to, the outer face of the outer sheet of glass 21 at the periphery of the glazing assembly 20 located in the rebate.

Preferably, and as shown in the figures, part of a resilient exterior seal 35, preferably made of a rubber or a rubber-like material, is located in a groove 36 formed at the distal edge 34 of the first side portion of the retainer. The exterior rubber seal provides a resilient cushion and seal between the distal edge of the cantilevered side portion of the retainer and the outer face of the glazing assembly. Thus, any pressure applied to the outer face of the glazing assembly by the cantilevered elongate side portion of the retainer is applied through the exterior rubber seal 35.

The second elongate side portion 32 of the retainer 30 is fastened to the framing member 4 by threaded screw fasteners 37 to resist outward movement, i.e. away from the glazing assembly, of the distal edge 34 of the first side portion and to thereby retain the periphery of the glazing assembly 20 in the rebate 8.

As may be best appreciated from FIG. 1, the second elongate side portion 32 of the retainer 30 extends from the intermediate portion 33 firstly in a direction away from the cantilevered first side portion 31 then, at a first return portion 38, in an opposite direction back toward the cantilevered first side portion.

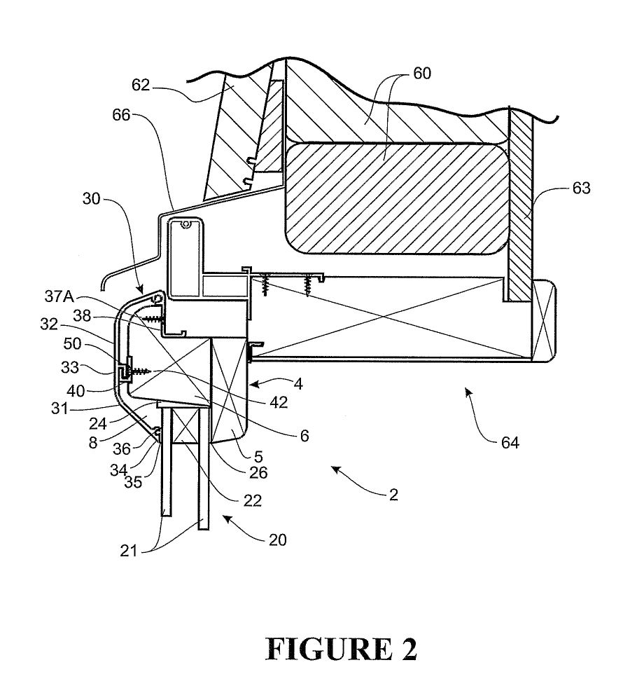

In the arrangement of the top rail 2 of the lower sash as shown at the bottom of FIG. 1, and in the arrangements of the rails shown in FIGS. 2, 3 and 4, the first return portion 38 is fastened to the framing member substrate 6 by threaded screw fasteners 37A.

The first return portion 38 of the second side portion 32 of the retainer 30 optionally has a further return portion 39 which extends in a direction away from the intermediate portion 33 of the retainer 30. In the arrangement of the lower rail of the upper sash as shown at the top of FIG. 1, the further return portion 39′ is fastened to the framing member substrate 6′ by threaded screw fasteners 37B.

The two sash rails shown in FIG. 1 are similar, other than size (the one shown at the bottom of the figure having a relatively elongated cross-sectional shape when compared to that shown at the top of the figure) and the variation of the further return portion 39 and the location of the fasteners 37 by which the retainer 30 is secured to the substrate 6. With the exception of the rails themselves and the fasteners 37 (the latter being respectively shown as 37A and 37B), all numbered features apply equally to both sash rails. Like numbers are used for corresponding features in both cases with primed numbers used to label the features of the rail 1 of the sash shown at the top of FIG. 1.

The further return 39 can have a lip 44, in which case the rail provides a channel by which water penetrating behind the front of the sash may be carried away. For example, rainwater may be channelled across the top of the top rail 2 of the lower sash shown in FIG. 1 and directed to one or other side of the sash for discharge down the side and away at a sill.

Alternatively (but not shown in the drawings), both the first return portion 38 and the further return portion 39 of the second side portion 32 of the retainer 30 may be fastened to the substrate 6 of the framing member 4.

The window sash is typically made by first assembling a structural sash frame from four timber framing members 4. Both ends of each of the four members are mitred for forming the corners of the sash. Respective clips 40 are fastened to the outermost faces of the four framing member by screw fasteners 42. A suitably sized double glazing assembly 20 is fitted into the rebates 8 of the four members with peripheral packers 24 and seals 26 fitted as shown in the figures.

A respective retainer 30 is interlocked into each clip 40 to retain the glazing assembly in the sash. The intermediate portion 33 of each retainer has a projection 50 which engages a respective one of the U-shaped clips 40 to interlock the retainer to the framing substrate. The projection 50 has an L-shaped cross-section having a proximal limb and a distal limb. The distal limb of the L-shaped cross-section extends away from the proximal limb in a direction toward the cantilevered first side portion 31 of the retainer 30 and is fitted into the gap between the limbs of the U-shape of the clip 40 to interlock the retainer 30 to the framing member 4. The retainer is thereby interlocked with the framing member by engagement of the distal limb of the L-shaped cross-section of the projection of the intermediate portion of the retainer with the framing member. The return portion 38 of the second elongate side 32 of the retainer 30 engages the inward facing face of a projection 52 of the framing substrate 6.

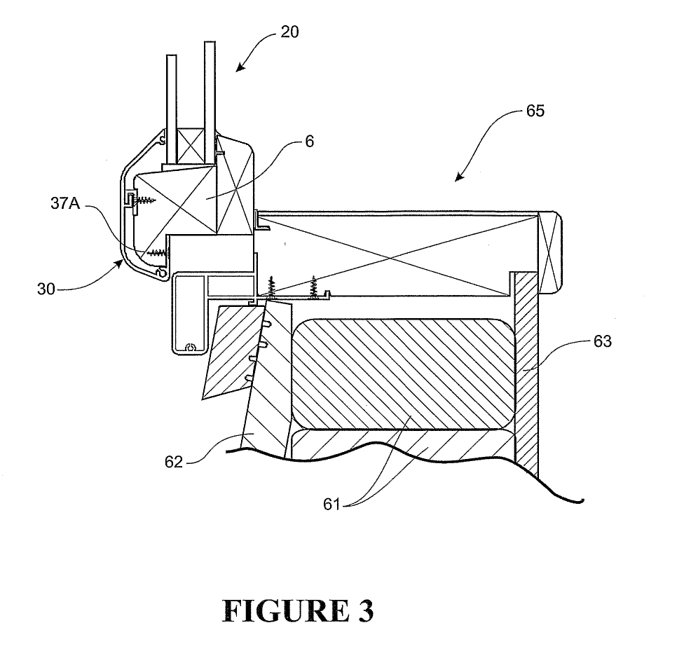

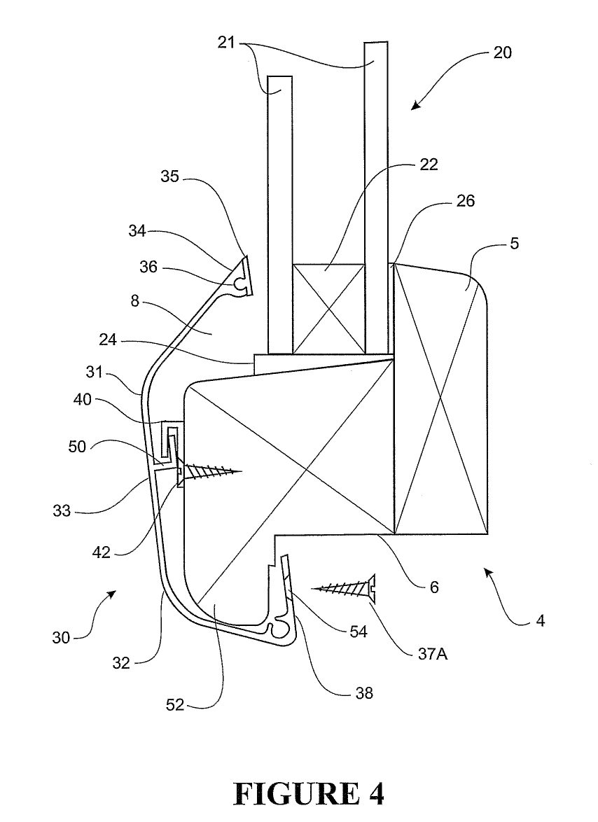

FIG. 4 shows a partly-assembled bottom rail of a window sash. This sash rail is similar to, and has features in common with, the sash rails described above and particularly the sash rail shown in FIG. 3 which uses fasteners 37A to secure a retainer 30 to a substrate 6 of a structural framing member 4 of the rail.

In the embodiment shown in FIG. 4, the gap between the limbs of the U-shaped clip 40 is slightly larger than the thickness of the distal limb of the projection 50 of the intermediate portion of the retainer. This difference allows the retainer 30 to be interlocked with the clip 40 while the exterior seal 35 at the distal edge 34 of the first side portion 31 of the retainer is clear of, i.e. is not in contact with, the glazing assembly 20.

The retainer can then be rotated (clockwise as would be seen in the view of FIG. 4) to bring the external seal 35 into contact with, and apply pressure to, the outermost surface of the glazing assembly 20. The retention pressure against the glazing assembly is maintained by fitting screw fasteners 37A in apertures 54 in the first return portion 38 and then screwing these fasteners into the substrate 6.

It is to be appreciated that, where the retainer has a further return portion 39 as described above, retention pressure against the glazing assembly can alternatively or additionally be maintained by the fitting of fasteners 37B in apertures in the further return portion 39 and the screwing of these fasteners 37B into the substrate 6.

As the retainer is rotated into the final fully-assembled position, as shown in FIGS. 1 to 3, retention pressure is brought to bear by the exterior seal 35 against the glazing assembly 20.

Alternatively, the exterior seal 35 at the distal edge 34 of the first elongate side 31 of the retainer 30 may be placed on the outer face of the glazing assembly 20 and the retainer 30 slid rectilinearly into place with the L-shaped projection 50 engaging the U-shaped clip 40 and the first return portion 38 of the second elongate side 32 engaged against the outermost face of the projection 52 of the framing substrate 6.

In a typical application as noted above, the ends of the framing members and the retainer are mitred for forming the comers of the sash. For example, in a rectangular sash the ends are angled at 45 degrees. In assembly of the sash, a retainer is slid into position between respective ends of two adjacent retainers. As the retainer is slid into position, the distal limb of the cross-sectional shape of the projection of the intermediate portion of the retainer engages the clip. The orientation of the distal limb toward the cantilevered longitudinal edge of the retainer allows the retainer to slide and/or rotate into position with the mitred ends in close fitting contact between the correspondingly mitred ends of the two adjacent retainers of the sash. The orientation of the distal end of the retainer projection means that the retainers are moved inwards, toward the centre of the sash, to bring the retainers into their final assembled position.

Whether assembly is by rotation or rectilinear sliding, the assembly of the retainer 30 to the framing member 4 may be achieved without any reduction in the inward pressure applied to the outer face of the glazing assembly 20 by the exterior seal 35 at the distal edge 34 of the cantilevered side portion 31 of the retainer 30.

Referring particularly to the arrangements shown in the lower sash shown in FIG. 1 or in the sashes shown in FIGS. 2, 3 or 4, it should be appreciated that as the screw fastener 37A is screwed home, bringing the return portion 38 of the second elongate side 32 of the retainer 2 up against, or at least closer to, the inward facing face of the projection 52 of the framing substrate 6, there is a tendency for the retainer 30 to rotate (anti-clockwise as viewed in the figures) about a virtual pivot axis provided by the engagement of the L-shaped projection 50 in the U-shaped clip 40, thereby urging the exterior seal 35 at the distal edge 34 of the cantilevered side portion 31 of the retainer 30 inward toward the glazing assembly 20.

The sash can therefore be assembled without any reduction in the pressure applied by the exterior seal 35 against the glazing assembly 20 during assembly. The pressure is at least maintained at a steady level, or is increased monotonically, during the assembly as described above for retention of the gazing assembly 20 in the rebate 8 in the framing substrate 6.

To disassemble the sash framing construction described above, for example to remove the glazing assembly, the retainer 30 of at least one and preferably all of the rails and stiles of the sash must be removed. The retainers can be removed by disengaging the distal arm of the projection 50 from interlocking engagement with the clip 40. This can only be done after removal of the fasteners 37 used to secure the retainer to the framing substrate 6.

As described above, the fasteners may be either fasteners 37A fitted through apertures in the first return portion 38 of the retainer, or fasteners 37B fitted through apertures in the further return portion 39 of the retainer. In either case, these fasteners are not accessible when the sash is closed in the window frame. The fasteners are only accessible when the sash is not closed in the frame. The concealment of the fasteners in a closed sash offers improved security and weather resistance.

Thus, by simply closing the sash in the frame and securing it in the closed position by a catch or latch at the interior side of the window, the window secures the building against unauthorised access that might be gained through the window after removal of the glazing assembly.

It is also to be noted that, in contrast to some prior art arrangements, removal of the exterior seal 35 does not affect the security of the assembled sash. In particular, removal of the exterior seal does not put the security of the connection of the retainer to the sash framing member in jeopardy.

It should also be appreciated that the retainer secures the glazing assembly in the sash without requiring the application of any sealant or adhesive. This is in contrast to prior art sash systems which use silicone or other adhesive sealants to secure and retain the glazing, and/or the exterior aluminium profiles, in the sash. This distinction is of particular significance when re-glazing is required, such as when replacing a broken pane. In a sash using the current invention, the glass or glazing assembly 20 can be removed simply by removing the screw fasteners 37 and easing out the aluminium retainers 30. After removing the broken pane or glazing assembly, and fitting of a replacement, re-assembly of the sash is a simple reversal of the procedure. No sealant or adhesive need be removed or re-applied. Replacement of the glazing can be readily performed by a homeowner, using only a small screwdriver, to restore the sash back to its original factory-built quality and without incurring the costs associated with employing a tradesperson.

The invention has been described with reference to sashes in a window frame installed in an external wall of a timber framed building. The wall has timber framing elements (for example timber framing elements 60, 61 seen in FIGS. 2 or 3). The wall framing is clad on the exterior side by weatherboards (for example weatherboards 62 seen in FIGS. 2 and 3) and on the interior side by lining (for example lining 63 seen in FIGS. 2 and 3). The window frame has a head (for example head 64 seen in FIG. 2) and a sill (for example sill 65 seen in FIG. 3). A head flashing (for example head flashing 66 seen in FIG. 2) is preferably incorporated to divert rainwater away from the window frame.

The foregoing describes the invention with reference to a preferred embodiment. Alterations and modifications as will be obvious to those skilled in the art are intended to be incorporated within the scope of the invention as defined in the accompanying claims. For example, although the preferred embodiment described above refer to the use of fasteners, and screw threaded fasteners in particular, other attachment methods or fasteners may be utilised. For example, pins, pegs, nails, or adhesives may be used. Of course it is usually desirable that some provision is made for disassembly, for example to replace broken or damaged glazing units. The use of screw threaded fasteners can be advantageous when straightforward disassembly is required.

The term ‘comprising’ as used in this specification and claims means ‘consisting at least in part of’. That is to say, when interpreting statements in this specification and claims which include that term, the features, prefaced by that term in each statement, all need to be present but other features can also be present.

### LIST OF FEATURES LABELLED IN THE FIGURES

bottom rail 1
top rail 2
transom 3
structural framing member 4
timber facing 5
substrate 6
rebate 8
double glazing assembly 20
glass sheet 21
spacer 22
bevelled packer 24
interior seal 26
retainer 30
first side portion 31
second side portion 32
intermediate portion 33
edge 34
exterior seal 35
groove 36
screw fastener 37
first return portion 38
further return portion 39
clip 40
screw fastener 42
lip 44
L-shaped retainer projection 50
substrate projection 52
aperture 54
framing elements 60, 61
weatherboard 62
lining 63
head 64
sill 65
head flashing 66

1. A frame construction for supporting a panel member in a door or window sash, the frame construction comprising:
a framing member which is elongate and has a rebate for accommodating a peripheral portion of the panel member, the framing member having a transverse cross-sectional shape which is substantially constant along at least a major portion of the length of the framing member; and
a retaining member for retaining the panel member in the rebate, wherein the retaining member is elongate and has a transverse cross-sectional shape which is substantially constant along at least a major portion of the length of the retaining member, the retaining member has first and second longitudinal side portions which are respectively located on opposite sides of a longitudinal intermediate portion, the first side portion of the retaining member cantilevers over the rebate in the framing member, the intermediate portion of the retaining member includes a projection which has an L-shaped cross-section with a distal limb of the L-shaped cross-section extending away from a proximal limb of the L-shaped cross-section in a direction toward the cantilevered first side portion, and the retaining member is interlocked with the framing member by engagement of the distal limb of the L-shaped cross-section of the projection of the intermediate portion of the retaining member with the framing member.

2. A frame construction as claimed in claim 1, wherein a seal is fitted to a distal edge of the cantilevered first side portion of the retaining member.

3. A frame construction as claimed in claim 2, wherein the seal is a rubber seal, and the seal is secured to the retaining member by fitting at least partially into a groove formed in the retaining member at the distal edge.

4. A frame construction as claimed in claim 1, further comprising a panel member, a peripheral portion of the panel member being accommodated in the rebate.

5. A frame construction as claimed in claim 4, wherein a distal edge of the cantilevered first side portion of the retaining member applies a steady or monotonically increasing pressure to the peripheral portion of the panel member accommodated in the rebate when the intermediate portion of the retaining member is being interlocked with the framing member and the second side portion of the retaining member is being fastened to the framing member.

6. A frame construction as claimed in claim 4, wherein the panel member is a sheet of glass.

7. A frame construction as claimed in claim 4, wherein the panel member is a glazing assembly.

8. A frame construction as claimed in claim 7, wherein the glazing assembly comprises two or more sheets of glass spaced apart from one another by at least one spacer.

9. A frame construction as claimed in claim 1, wherein the framing member comprises a substrate and at least one clip, the at least one clip is fastened to the substrate, and the retaining member is interlocked with the framing member by engagement of the distal limb of the L-shaped cross-section of the projection of the intermediate portion of the retaining member with the clip.

10. A frame construction as claimed in claim 9, wherein the substrate is made of timber.

11. A frame construction as claimed in claim 9, wherein the at least one clip is elongate and has a transverse cross-sectional shape which is substantially constant along at least a major portion of the length of the clip.

12. A frame construction as claimed in claim 11, wherein the at least one clip is an aluminium extrusion.

13. A frame construction as claimed in claim 9, wherein the at least one clip is fastened to the substrate by at least one fastener.

14. A frame construction as claimed in claim 1, wherein the retaining member is an aluminium extrusion.

15. A frame construction as claimed in claim 1, wherein the second side portion of the retaining member is fastened to the framing member by at least one fastener.

16. A frame construction as claimed in claim 1, wherein the frame construction is incorporated into a sash mounted in a frame and the second side portion of the retaining member is fastened to the framing member by at least one fastener which is inaccessible when the sash is closed in the frame.

17. A frame construction as claimed in claim 15, wherein the second side portion of the retaining member extends from the intermediate portion firstly in a direction away from the cantilevered first side portion, then secondly, at a first return portion, in an opposite direction back toward the cantilevered first side portion.

18. A frame construction as claimed in claim 17, wherein the first return portion is fastened to the framing member by at least one fastener.

19. A frame construction as claimed in claim 17, wherein the frame construction is incorporated into a sash mounted in a frame and the first return portion is fastened to the framing member by at least one fastener which is inaccessible when the sash is closed in the frame.

20. A frame construction as claimed in claim 17, wherein the first return portion of the second side portion of the retaining member has a further return portion which extends in a direction away from the intermediate portion of the retaining member.

21. A frame construction as claimed in claim 20, wherein the further return portion is fastened to the framing member by at least one fastener.

22. A frame construction as claimed in claim 20, wherein the frame construction is incorporated into a sash mounted in a frame and the further return portion is fastened to the framing member by at least one fastener which is inaccessible when the sash is closed in the frame.

23. A frame construction as claimed in claim 13, wherein any one said fastener is a threaded screw fastener.

24. A frame construction as claimed in claim 15, wherein any one said fastener is a threaded screw fastener.

25. A frame construction as claimed in claim 18, wherein any one said fastener is a threaded screw fastener.

26. A frame construction as claimed in claim 19, wherein any one said fastener is a threaded screw fastener.

27. A frame construction as claimed in claim 21, wherein any one said fastener is a threaded screw fastener.

28. A frame construction as claimed in claim 22, wherein any one said fastener is a threaded screw fastener.
